(19) United States
(12) Patent Application Publication
(10) Pub. No.: US 2024/0037478 A1
(43) Pub. Date: Feb. 1, 2024

(54) Virtual event platform event engagement

(71) Applicant: Hubilo Technologies, Inc., San Francisco, CA (US)

(72) Inventor: Kumar Kishin Jhuremalani, Bangalore (IN)

(73) Assignee: Hubilo Technologies, Inc., San Francisco, CA (US)

(21) Appl. No.: 18/226,937

(22) Filed: Jul. 27, 2023

(30) Foreign Application Priority Data
Jul. 28, 2022 (IN) 202241043242

(51) Int. Cl. G06Q 10/0639

(52) U.S. Cl. CPC G06Q 10/06393

(57) ABSTRACT

An event organizer organizes and implements a virtual event. In connection therewith, the event organizer defines a set of high value actions (HVAs) for the event. The nature of the HVAs will vary depending on the event organizer, type of event, the available attendee activities, and the identity of the participants and the activities that are available to them at the event. The high value actions are prioritized, and weights are then attached to these actions. Once the event begins, participants at the virtual event engage in event touch points, and each participant-touch point interaction is monitored and recorded by the back-end systems. Typically, a participant engages in a touch point by selecting a display tab directed to that feature and exposed to the user on his or her browser during the virtual event. Based on the HVAs and their priorities and weightings, an event engagement score is then computed, preferably for each participant, and the event engagement scores for preferably all of the participants are then aggregated and used to generate an event engagement score for the event as a whole. Once the event engagement score is computed for the entire event, that score can then be exposed in an event ranking by which the organizer can then determine the effectiveness of the event as compared to other virtual events.

### BACKGROUND

### Technical Field

This disclosure relates generally to technologies, products and services for online collaboration and, in particular, to techniques for enabling virtual event engagement-related analytics.

### Background of the Related Art

A virtual event is an online event that involves people interacting in a virtual environment instead of meeting in a physical location. Virtual events are typically multi-session online events that often feature webinars and webcasts. Such events are designed to be highly interactive. Popular uses of virtual events include virtual conferences, virtual sales meetings, and virtual company-wide gatherings. They are used by organizations to deliver presentations, training, internal meetings, and other interactive sessions. Existing virtual event platforms have provided significant advantages especially in the recent past, where individuals and organizations have found it difficult to gather together in a physical location due to the global pandemic.

Existing virtual event platforms do attempt to capture information about a participant's activities at an event. For example, a virtual event platform may record that a participant participated in a poll, asked a question during a session, entered a networking lounge, participated in a contest, or the like. The collected data may then be exposed to the event organizer, e.g., in a web-accessible dashboard. This information, however, is generally limited to individual metrics and statistics, and thus there is no event-wide or aggregated view of overall engagement within an event. Existing systems also do not provide any mechanism to enable an event organizer/planner to determine how well a particular virtual event perform (engagement-wise) with respect to such events.

The techniques herein address this need.

### BRIEF SUMMARY

According to this disclosure, a virtual event platform is augmented to provide enhanced engagement analytics. To that end, an event engagement score is calculated based on overall engagement within an event, and that score also is used to provide an indication of a relative ranking of the event with respect to other such events.

In an example, embodiment, an event organizer organizes and implements a virtual event. In connection therewith, the event organizer defines a set of high value actions (HVAs) for the event. The nature of the HVAs will vary depending on the event organizer, type of event, the available attendee activities, and the identity of the participants and the activities that are available to them at the event. The high value actions are prioritized, and weights are then attached to these actions. Once the event begins, participants at the virtual event engage in event touch points, and each participant-touch point interaction is monitored and recorded by the back-end systems. Typically, a participant engages in a touch point by selecting a display tab directed to that feature and exposed to the user on his or her browser during the virtual event. Based on the HVAs and their priorities and weightings, an event engagement score is then computed, preferably for each participant, and the event engagement scores for preferably all of the participants are then aggregated and used to generate an event engagement score for the event as a whole. Once the event engagement score is computed for the entire event, that score can then be exposed in an event ranking by which the organizer can then determine the effectiveness of the event as compared to other virtual events.

The foregoing has outlined some of the more pertinent features of the subject disclosure. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 depicts a representative service provider platform on which virtual events are configured and hosted;

FIG. 2 depicts a representative live video webcast and the supporting service provider infrastructure that operates during an event;

FIG. 3 depicts a representative HVA configuration table implemented for a particular event; and

FIG. 4 depicts a representative dashboard depicting one way in which event engagement and event rankings may be exposed to the event organizer.

### DETAILED DESCRIPTION

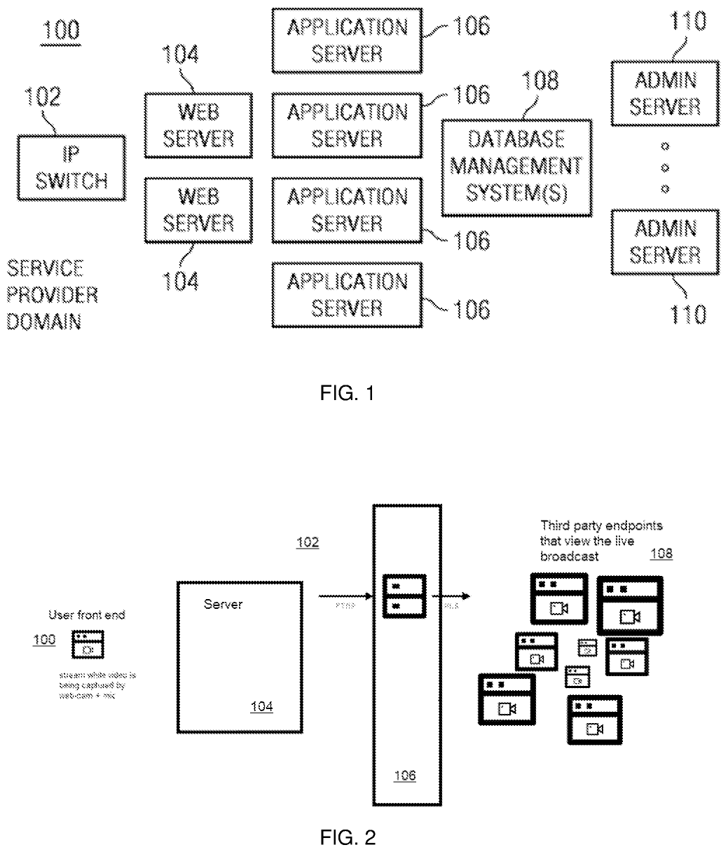

The following provides background regarding representative computing infrastructure that implements a virtual event platform. In particular, FIG. 1 illustrates a representative virtual event platform service provider or system architecture, which in one embodiment is implemented in or across one or more data centers. A data center typically has connectivity to the Internet. The system provides a web-based hosted solution through which service customers and their users (e.g., organizers, planners, participants, and the like) plan, design, develop, organize, manage and implement a virtual event. Typically, all such users interact with the platform as a hosted service. In an alternative embodiment, the system may be implemented over a private network, or as a product (as opposed to a hosted or managed service).

A user of the service has an Internet accessible machine such as a workstation, notebook, laptop, mobile device (smart phone or tablet) or other network-connected appliance. Typically, the user accesses the service provider architecture by opening a web browser on the machine to a URL associated with a service provider domain or sub-domain. The user then authenticates to the managed service in the usual manner, e.g., by entry of a username and password. The connection between the machine and the service provider infrastructure may be encrypted or otherwise secure, e.g., via SSL, or the like. Although connectivity via the publicly-routed Internet is typical, the user may connect to the service provider infrastructure over any local area, wide area, wireless, wired, private or other dedicated network. As seen in FIG. 1, the service provider architecture 100 comprises an IP switch 102, a set of one or more web server machines 104, a set of one more application server machines 106, a database management system 108, and a set of one or more administration server machines 110. A representative web server machine 104 comprises commodity hardware, an operating system such as Linux, and a web server. A representative application server machine 106 comprises commodity hardware, Linux, and an application server. The database management system 108 may be implemented as an Oracle database management package. In a high volume use environment, there may be several web server machines, several application server machines, and a number of administrative server machines. Although not shown in detail, the infrastructure may include a name service, other load balancing appliances, other switches, network attached storage, and the like. The system typically will also include connectivity to external data sources, such as third party databases. Each machine in the system typically comprises sufficient disk and memory, as well as input and output devices. Generally, the web servers 104 handle incoming provisioning requests, and they export a display interface that is described and illustrated in more detail below. The application servers 106 manage the data and facilitate the functions of the platform. The administrator servers 110 handle all back-end accounting and reporting functions. These reporting functions typically comprise one or more web-accessible dashboards, data feeds, and the like. The application servers support analytics engines that carry out the techniques described below. The particular hardware and software implementation details described herein are merely for illustrative purposes are not meant to limit the scope of the disclosed subject matter.

FIG. 2 depicts a typical way in which an end user participates in a virtual event. In this example, the virtual event at issue is a live video webcast involving a presenter and a set of one or more recipients. In this example, each person involved in the collaboration has a computing machine (e.g., a desktop, a laptop, a tablet, a smart phone, or the like) having a processor, memory, storage, I/O, and display. As depicted, the presenter has a computing machine 200 comprising input devices such as a webcam and microphone. The service providers 202 provide infrastructure supporting the collaboration. For browser-based collaboration, the presenter opens his or her browser to a session and begins speaking (broadcasting). The webcam and microphone capture the presenter's video and audio, and these streams are transmitted, typically via a WebRTC connection, to a server 204. The server joins the broadcast and captures video frames and audio (e.g., using an architecture based on Jitsi, an open source video conferencing framework). These frames and audio are then encoded and output from the server over RTMP to a delivery system 206. Delivery system 206 transcodes the output(s) received from the server 204 into a suitable delivery format (e.g., HLS), and publishes the broadcast, e.g., as an RTMP stream available at a URL. Delivery may involve a content delivery network (CDN), which is not shown. Participants 208 open their respective browser(s) to the stream URL and watch the presentation on their local computing machines.

Virtual event participants (such as those watching the live video webcast, or participating in some other event activity) interact in many different ways. According to the approach here, participant (attendee) engagement is defined as a set of (and preferably every) active touch point that an attendee has on the platform (and during the event). In other words, engagement occurs whenever an attendee is making an effort to perform an action on the platform for various tasks related to an event. When individuals attend a physical event, traditional event engagement touch points include networking with other attendees, exchanging business cards, visiting booths, dropping business cards at booths, attending a session on a main stage, asking questions to speakers, attending a breakout room session, asking a question, taking a photograph, sharing an experience on social media, and taking part in raffles and contests. Many of these touch points have direct analogs in the virtual environment, and they can even be expanded further, e.g.: networking (viewing a profile, starting a chat, request a meeting, and so forth); visiting a virtual “booth” (call-to-action (CTA) button, watching videos hosted within the booth, viewing product details (e.g., by requesting additional files), downloading files, chatting with booth members, taking part in Q&A, taking part in polls, or the like); attending a session on “main” stage (watch, chat with fellow attendees, ask a question, take part in polls, view profiles of other attendees, or the like); attending a breakout room session (watch, option to join on-screen, chat with fellow attendees, ask a question, take part in polls, view profiles of other attendees, and the like), and other such activities. The above are just representative.

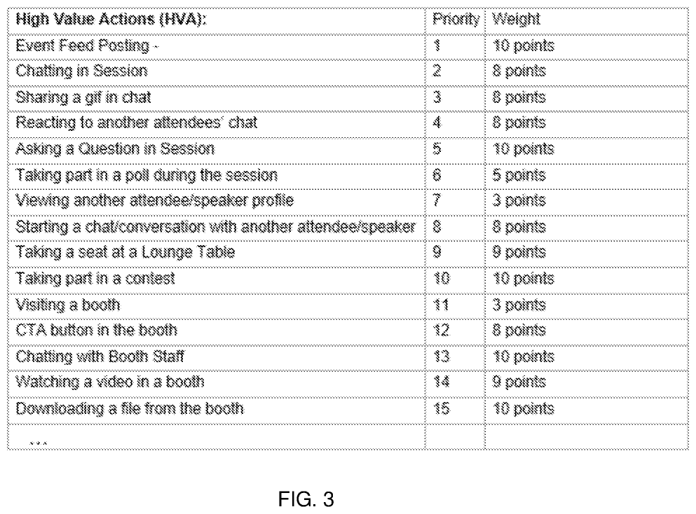

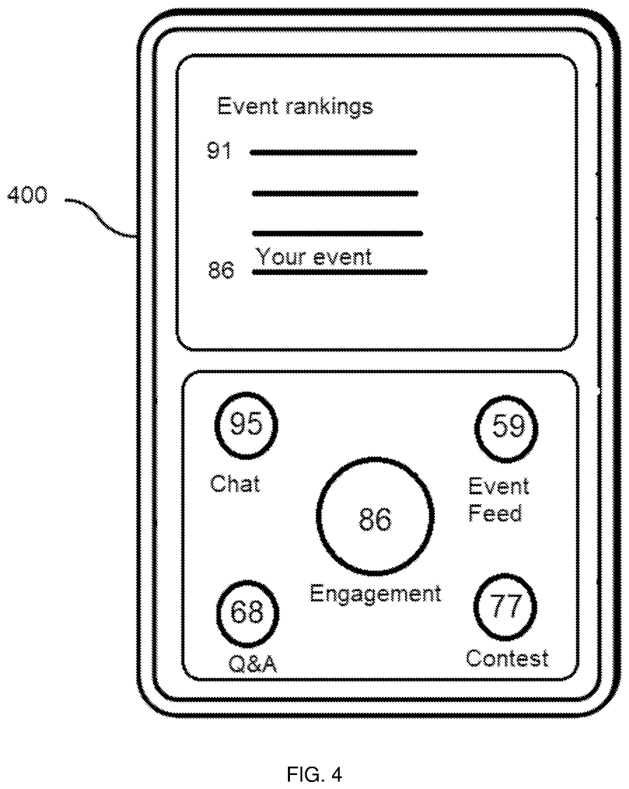

According to this disclosure, an event organizer organizes and implements a virtual event. In connection therewith, the event organizer defines a set of high value actions (HVAs) for the event. The nature of the HVAs will vary depending on the event organizer, type of event, the available attendee activities, and the identity of the participants and the activities that are available to them at the event. The high value actions are prioritized, and weights are then attached to these actions. FIG. 3 depicts a represent set of HVAs that have been configured for an event. This example is not intended to be limiting. In a variant embodiment, the service provider (that operates the virtual event platform) provides a default set of HVAs and their associated priorities and weightings. Participants at the virtual event engage in event touch points, such as identified above, and each participant-touch point interaction is monitored and recorded by the back-end systems. Although not intended to be limiting, typically a participant engages in a touch point by selecting a display tab directed to that feature and exposed to the user on his or her browser during the virtual event. Based on the HVAs and their priorities and weightings, an event engagement score is then computed, preferably for each participant, and the event engagement scores for preferably all of the participants are then aggregated and used to generate an event engagement score for the event as a whole. Once the event engagement score is computed for the entire event, that score can then be exposed in an event ranking by which the organizer can then determine the effectiveness of the event as compared to other virtual events. Thus, for example, and with reference to FIG. 4, a portion of a reporting dashboard (exposed as a set of one or more secure web pages) is then made available to the event organizer. In this example, the upper portion of the dashboard depicts the event engagement rank (in this case “86”) for the organizer's event with respect to other events. The other events may be past (historical) events that were implemented by the organizer (or others) , one or more events that are taking place concurrently on the virtual event platform (including those hosted by other platform customers), or some combination thereof. In this manner, the event engagement is cross-referenced to one or more other events so that the organizer can ascertain how its events fared in terms of engagement. The ranking may be color-coded (from best to worst). The bottom portion of the view in FIG. 4 displays the event engagement details directly. In a typical use case, the user navigates to this portion by selecting a link in the engagement rankings and, in particular, the link associated with the organizer's event. In this example, the overall engagement score is shown in the middle diagram, with various individual engagement scores for certain identified touch points (e.g., chat, event feed, Q&A participation, and contest participation) also depicted. The example dashboard is not intended to be limiting, as the particular display of the engagement analytics may use other techniques, such as pie charts, heat maps, histograms, and many others.

Generalizing, after the organizer defines the HVAs for the event and the event is initiated, the system tracks if an attendee engages with any of the touch points (including the HVAs). For each individual engagement, a context analysis is performed. In particular, a score is calculated per attendee based on the weights that have been assigned. The score(s) for the event participants are computed in a like manner and then aggregated with respect to a total possible engagement score of 100. Preferably, there are one or more adjustments that are then made to the raw engagement score for the event. In one adjustment, the system tracks the number of attendees that actual attend the event versus the number of registrations for the event. If there is a discrepancy in attendees versus registrations, then the event engagement score is decreased. Another type of adjustment considers event type and ensures that the overall engagement score is not inappropriately biased (downward) because a particular event type was not active for the event. To provide a concrete example, if a content/engage feature tab is not active during the event, the overall engagement score should not include a 0 value (which would bias the overall number downward); rather, in such case the overall engagement score is derived from the features that the system determines were actually active during the event (or some relevant portion thereof). This type of adjustment is advantageous, as there may be particular features of the event that either are not reachable, that have been configured incorrectly, or the like, such that an attended is unable to reach them despite having an intent to do so. The event engagement score may also be adjusted based on HVA frequency.

As noted above, preferably the event organizer interacts with the platform to define the HVAs. After an event, the organizer can adjust those weightings, e.g., based on the particular features of the event and their relative contributions to the overall engagement score. In this regard, the system may provide cues and hints to the organizer through the dashboard on how to improve the organizer's overall ranking. As an example, the system (through its collection of similar data from others that use the event platform) may determine that prioritizing event feeds over chats has a tendency to depress overall engagement; in such case the system may provide a cue/hint to the organizer to adjust its relative weightings for these features accordingly.

In a variant embodiment, the system tracks HVAs and associated weighting data as configured/applied across multiple events (and potentially across multiple organizers), based on such tracking and the event engagement scores from such events automatically determines a common set of such HVAs and weightings that are then applied automatically to one or more follow-on events. In this manner, the system learns an optimal HVA/weighting data set from the historical event engagement scores and activities, and then applies that data set automatically to participant activities during later events.

The techniques herein provide significant advantages. By computing and exposing the overall engagement score, the organizer is provided a metric by which it can determines the event's success, both with respect to internal goals and with respect to how others that provide virtual events. Using the approach herein, the event organizer can easily determine what feature(s) of the event worked, and which features did not. Given a low engagement score and a set of features for the event, the organizer can understand what features may be lacking for its events. In the latter case, the system itself may learn such information (by comparing the organizer's events to the events of others) and provide recommendations for improvement. Using the event engagement data, the organizer can creates better attendee experiences for its future events, and once again the system may provide hints to that end. Once an organizer's event scores have reached a high value, the value can then be used as a benchmark for other events of similarly-situated organizers.

As noted above, the virtual event platform typically hosts many events including from different event organizers (customers). Accordingly, and given the significant amount of engagement-related data collected by the platform, the service provider may implement machine learning techniques to generate classification or other models of event engagement. The nature and type of Machine Learning (ML) algorithms that are used to process the event engagement data (from other events) into one or more data models may vary. In general, the ML algorithms iteratively learn from the event-captured data, thus allowing the system to find hidden insights without being explicitly programmed where to look. ML tasks are typically classified into various categories depending on the nature of the learning signal or feedback available to a learning system, namely supervised learning, unsupervised learning, and reinforcement learning. In supervised learning, the algorithm trains on labeled historic data and learns general rules that map input to output/target. The discovery of relationships between the input variables and the label/target variable in supervised learning is done with a training set, and the system learns from the training data. In this approach, a test set is used to evaluate whether the discovered relationships hold and the strength and utility of the predictive relationship is assessed by feeding the model with the input variables of the test data and comparing the label predicted by the model with the actual label of the data. The most widely used supervised learning algorithms are Support Vector Machines, Linear Regression, Logistic Regression, Naive Bayes, and Neural Networks.

In unsupervised machine learning, the algorithm trains on unlabeled data. The goal of these algorithms is to explore the data and find some structure within. The most widely used unsupervised learning algorithms are Cluster Analysis and Market Basket Analysis. In reinforcement learning, the algorithm learns through a feedback system. The algorithm takes actions and receives feedback about the appropriateness of its actions and based on the feedback, modifies the strategy and takes further actions that would maximize the expected reward over a given amount of time.

The following provides additional details regarding supervised machine learning. As noted above, supervised learning is the machine learning task of inferring a function from labeled training data. The training data consist of a set of training examples. In supervised learning, typically each example is a pair consisting of an input object (typically a vector), and a desired output value (also called the supervisory signal). A supervised learning algorithm analyzes the training data and produces an inferred function, which can be used for mapping new examples. An optimal scenario allows for the algorithm to correctly determine the class labels for unseen instances. This requires the learning algorithm to generalize reasonably from the training data to unseen situations.

Generalizing, one or more functions of the described system may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Content delivery for the virtual event may be carried using a commercial CDN service.

The virtual event platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

### Additional Enabling Technologies

A typically computing device associated with an event participant is a mobile device or tablet computer. Such a device typically comprises a CPU, computer memory, such as RAM, and a drive. The device software includes an operating system (e.g., Apple iOS, Google® Android™, or the like), and generic support applications and utilities. The device may also include a graphics processing unit (GPU). It also includes a touch-sensing device or interface configured to receive input from a user's touch and to send this information to the processor. The touch-sensing device typically is a touch screen. The touch-sensing device or interface recognizes touches, as well as the position, motion and magnitude of touches on a touch sensitive surface (gestures). The device typically also comprises a high-resolution camera for capturing images, an accelerometer, a gyroscope, and the like.

In one embodiment, a service provider provides the virtual event hosting platform, and any necessary identity management service or support. A representative platform of this type is available from Hubilo Technologies, Inc.

The cloud service is a technology platform that may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the cloud service comprises a set of one or more computing-related entities (systems, machines, processes, programs, libraries, functions, or the like) that together facilitate or provide the functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The computing entity on which the browser and its associated browser plug-in run may be any network-accessible computing entity that is other than the mobile device that runs the authenticator app itself. Representative entities include laptops, desktops, workstations, Web-connected appliances, other mobile devices or machines associated with such other mobile devices, and the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

The techniques herein provide for improvements to technology or technical field, as well as improvements to various technologies, all as described.

Having described the subject matter, what is claimed is as follows.

1. A method for provisioning and managing a virtual event at a virtual event platform, comprising:
receiving data defining a set of actions for the virtual event, the set of actions each having an associated weighting, wherein at least a first action in the set has a weighting that differs from the weighting of a second action in the set;
upon initiation of the virtual event, receiving tracking data associated with participant activities with respect to the defined set of actions;
determining an engagement score for the virtual event using the received tracking data and the weightings for the set of actions; and
outputting the engagement score for the virtual event together with a comparison of the engagement score with respect to engagement scores from one or more other virtual events.

2. The method as described in claim 1 further including outputting additional information in associated with the engagement score, the additional information being generated by the virtual event platform based at least in part on the engagement scores from the one or more other virtual events.

3. The method as described in claim 2 wherein the additional information includes a recommendation with respect to at least one of: the set of actions, and a weighting associated with a particular action in the set of actions.

4. The method as described in claim 1 wherein the engagement score is a number.

5. The method as described in claim 1 wherein the set of actions include networking, visiting a virtual booth, and attending a session.

6. The method as described in claim 1 further including adjusting the engagement score based on a context analysis.

7. The method as described in claim 6 wherein the context analysis adjusts the engagement score based on a comparison of a number of participants at the virtual event compared to a total number of individuals registered to attend the virtual event.

8. The method as described in claim 6 wherein the context analysis adjusts the engagement score based on the availability of a given action during the virtual event.

9. The method as described in claim 6 wherein the context analysis adjusts the engagement score based on a frequency of the set of actions.

10. The method as described in claim 1 further including adjusting the set of actions and their associated weightings for a subsequent virtual event based at least in part on the engagement score.

11. The method as described in claim 10 wherein the adjusting is carried out in an automated manner.

12. Software-as-a-service infrastructure for provisioning and managing a virtual event, comprising:
a set of hardware processors;
computer memory holding computer program code executed by the one or more hardware processors, the computer program code comprising program code configured to:
receive data defining a set of actions for the virtual event, the set of actions each having an associated weighting, wherein at least a first action in the set has a weighting that differs from the weighting of a second action in the set;
upon initiation of the virtual event, receive tracking data associated with participant activities with respect to the defined set of actions;
determine an engagement score for the virtual event using the received tracking data and the weightings for the set of actions; and
output the engagement score for the virtual event together with a comparison of the engagement score with respect to engagement scores from one or more other virtual events.

13. A computer program product in a non-transitory computer-readable medium, the computer program product comprising computer program code executable by a hardware processor to provision and manage a virtual event, the computer program code configured to:
receive data defining a set of actions for the virtual event, the set of actions each having an associated weighting, wherein at least a first action in the set has a weighting that differs from the weighting of a second action in the set;
upon initiation of the virtual event, receive tracking data associated with participant activities with respect to the defined set of actions;
determine an engagement score for the virtual event using the received tracking data and the weightings for the set of actions; and
output the engagement score for the virtual event together with a comparison of the engagement score with respect to engagement scores from one or more other virtual events.
